(19) United States
(12) Patent Application Publication
(10) Pub. No.: US 2016/0162860 A1
(43) Pub. Date: Jun. 9, 2016

(54) CASH COUNT AUDIT SYSTEM

(71) Applicant: Carlos Andres GONZALEZ, Miami, FL (US)

(72) Inventor: Carlos Andres GONZALEZ, Miami, FL (US)

(21) Appl. No.: 14/549,971

(22) Filed: Nov. 21, 2014

Related U.S. Application Data
(63) Continuation-in-part of application No. 14/133,959, filed on Dec. 19, 2013.

(51) Int. Cl. G06Q 20/20

(52) U.S. Cl. CPC G06Q 20/202; G06Q 20/20

(57) ABSTRACT

A cash count auditing system, having a cash count audit apparatus, a POS, and documenting means to electronically capture and document a cashier, manager, and/or otherwise authorized individual's signature and/or fingerprint after balancing a respective POS. The cashier, manager, and/or otherwise authorized individual's signature and/or fingerprint, as part of a report is transmitted to a server having at least one database. The cash count auditing system is designed to document POS overages and/or shortages, reduce employee theft, and identify when further POS training is required for a particular cashier.

### BACKGROUND OF THE INVENTION

1. Field of the Invention

The present invention relates to auditing systems, and more particularly, to cash count auditing systems.

2. Other Related Applications

The present application is a continuation-in-part of pending U.S. patent application Ser. No. 14/133,959, filed on Dec. 19, 2013, which is hereby incorporated by reference.

3. Description of the Related Art

A cash register, also referred to as a till, is a mechanical or electronic device for calculating and recording sales transactions comprising an attached drawer for storing cash. The cash register also usually prints a receipt for a customer after a sales transaction. In most cases the drawer can be opened only after a sale, except when using special keys, which generally only the owner, if not also some employees, have. This reduces the risk of employees stealing from the shop owner by pocketing the money without recording a sale, when a customer does not need a receipt but has to be given change. Cash registers include a key labeled “NS”, which is abbreviated for “No Sale”, and opens the drawer, printing a receipt stating “No Sale” and recording it in the register log that the register was opened. Some other cash registers require a numeric password or physical key to be used when attempting to open the till.

Currently, many cash registers are individual computers. Many of them have touch screens and may be connected to computerized Point of Sale networks using any type of protocol. Such systems may be accessed remotely for the purpose of obtaining records or troubleshooting. Many businesses also use tablet computers as cash registers, utilizing the sale system as downloadable app-software.

Often cash registers are attached to scales, barcode scanners, check-stands, and debit card or credit card terminals. Increasingly, dedicated cash registers are being replaced with general-purpose computers with POS software. Cash registers, and their complementing equipment typically scan barcodes (usually EAN or Universal Product Code (UPC)) for each item, retrieve prices from a database, calculate deductions for items on sale, calculate sales tax, calculate differential rates for preferred customers, actualize inventory, time and date stamp transactions, record transactions in detail including each item purchased, record methods of payment, and keep totals for each product or type of product sold as well as tally total sales for specified periods. POS terminals will often also identify a cashier on the receipt, and carry additional information or offers.

At the end of a shift, the cashier typically has the responsibility of balancing the cash register, whereby the drawer and its contents are taken to prepare a report. Any overages and/or shortages should be investigated. Human nature should be taken into account for minor errors and small amounts. However, frequent discrepancies could be a sign of employee theft or may indicate further training is required for a particular cashier.

There are no other cash count auditing systems to the best of Applicant's knowledge that comprise a cash count audit apparatus to document a person's signature and/or fingerprint after balancing the cash register, and that further comprise means for scale configurations of the cash count audit apparatus and software updating from an offsite server.

### SUMMARY OF THE INVENTION

The instant invention is a cash count audit system. More specifically, the instant invention is a cash count auditing system, comprising a cash count audit apparatus, a POS, and documenting means to electronically capture and document a signature and/or fingerprint after balancing a respective POS. The signature and/or fingerprint, as part of a report are transmitted to a server having at least one database.

Further comprising a wireless technology standard for exchanging data over short distances using short-wavelength radio transmissions, wherein at least one POS communicates with its respective cash count audit apparatus. At predetermined time periods, a cashier will balance a respective POS, whereby its drawer and its contents are taken to prepare the report. Further comprising a wireless local area network, wherein at least one POS communicates with its respective cash count audit apparatus. At predetermined time periods, a cashier will balance a respective POS, whereby its drawer and its contents are taken to prepare the report. Further comprising a local area network, wherein at least one POS communicates with its respective cash count audit apparatus. At predetermined time periods, a cashier will balance a respective POS, whereby its drawer and its contents are taken to prepare the report. Further comprising a barcode reader. At predetermined time periods, a cashier will balance a respective POS, whereby its drawer and its contents are taken to prepare the report. The respective POS comprises printer that prints the report and the cash count audit apparatus scans the report and documents the signature and/or fingerprint.

The cash count audit apparatus comprises a base housing, and a cover that contains a touchscreen and a fingerprint reader. The cash count audit apparatus further comprises a tray cooperatively shaped to receive notes directly thereon, and/or a coin cup. Positioned and/or mounted onto the base housing are a main board, a rechargeable battery, a speaker, a weight measure cell, and/or a barcode reader interface. The main board comprises a first module for enabling wireless communications, and/or a second module wireless technology standard, for exchanging data over short distances using short-wavelength radio transmissions and a DSM/wireless modem. The tray comprises a post, and the cover comprises a hole that is of a cooperative shape and dimension to receive the post there through to secure onto the weight measure cell. The base housing comprises a power supply connector, a mini USB connector, a LAN connector, and/or a barcode reader window. The base housing comprises a battery compartment having a cover plate to contain at least one rechargeable battery.

Documenting means comprises the following steps: logging in and entering a cashier number and/or identification and a respective POS number using a touch screen on the cash count audit apparatus to develop a cash count audit apparatus report comprising amounts of cash for a respective POS. Generating the report including actual date and time. Physically counting the cash of respective POS including notes and coins using a tray of the cash count audit apparatus. Retrieving respective POS stored value amounts, establishing communication and imported/entered data received by the cash count audit apparatus is processed and stored in computer memory. Comparing a physical count result to a total value reported by the POS being audited. The cash count audit apparatus displays overages and/or shortages and prompts a respective signature and/or fingerprint to acknowledge the audit.

The cash count audit apparatus and at least one POS are configured to operate at multiple selling facilities. From each selling facility, the resulting reports, data, communications, and information may be transmitted through a world-wide-web to an operating business.

Further comprising updating means comprising the steps of securing an Internet connection by at least one communication module. Sending an electronic signal by the communication module to an offsite server requesting updated scale configurations and/or software. Proceeding to the first Step if the offsite server does not contain the updated scale configurations and/or software, and proceeding to the following Step otherwise; and downloading and installing the updated scale configurations and/or software onto the cash count audit apparatus. The downloading and installing of the updated scale configurations and/or software may also occur at predetermined periods and/or be pushed from the offsite server when desired and without a request.

It is therefore one of the main objects of the present invention to provide a cash count audit system that comprises a cash count audit apparatus to document a cashier, manager, and/or otherwise authorized individual's signature and/or fingerprint after balancing a cash register.

It is another object of this invention to provide a cash count audit system designed to document cash register overages and/or shortages.

It is another object of this invention to provide a cash count audit system designed to reduce employee theft.

It is another object of this invention to provide a cash count audit system designed to identify when further cash register training is required for a particular cashier.

It is another object of this invention to provide a cash count audit system that uses an innovative internal firmware and a new advanced communication module as interface, which allow its integration with other systems and resources located on site or remotely.

It is another object of this invention to provide a cash count audit system that allows two-way communication of specific information and commands.

It is another object of this invention to provide a cash count audit system that notifies select individuals of the activity or identification of cash register overages and/or shortages.

It is another object of this invention to provide a cash count audit system that downloads updated software versions to the actual cash count audit apparatuses.

It is another object of this invention to provide a cash count audit system that collects historical data from the cash count audit apparatuses for use in researching and analyzing cash register overages and/or shortages.

It is another object of this invention to provide a cash count audit system that identifies any service needed or down cash count audit apparatuses.

It is another object of this invention to provide a cash count audit system that comprises cash count audit apparatuses with network capability and static IP addresses, and local or wide area networks that connect to the Internet.

It is another object of this invention to provide a cash count audit system that comprises a dedicated web server that collects information from the cash count audit apparatuses and then processes them according to established business rules.

It is yet another object of this invention to provide such a system that is inexpensive to implement and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1A represents a diagram of a preferred embodiment cash count audit system utilizing a wireless technology standard for exchanging data over short distances using short-wavelength radio transmissions.

FIG. 1B represents a diagram of a first alternate embodiment cash count audit system utilizing a wireless local area network.

FIG. 1C represents a diagram of a second alternate embodiment cash count audit system utilizing a local area network.

FIG. 1D represents a diagram of a third alternate embodiment cash count audit system utilizing a barcode reader.

FIG. 2 is an isometric view of the cash count audit apparatus of the instant invention.

FIG. 3 is an exploded view of the cash count audit apparatus seen in FIG. 2.

FIG. 4 is a rear isometric view of the cash count audit apparatus.

FIG. 5A is a bottom isometric view of the cash count audit apparatus.

FIG. 5B is an enlarged view of a cash count audit apparatus accessories compartment represented in FIG. 5A.

FIG. 6 is an isometric view of the cash count audit apparatus documenting a cashier, manager, and/or otherwise authorized individual's signature and/or fingerprint after balancing a cash register.

FIG. 7 represents a flowchart of the cash count audit system.

FIG. 8 is a scale configuration and/or software updating means event flowchart.

FIG. 9 represents a block diagram of the cash count audit system at multiple selling facilities.

### DETAILED DESCRIPTION OF THE PREFERRED EMBODIMENT

Referring now to the drawings, the present invention is a cash count audit system and is generally referred to with numeral 10. It can be observed that it basically includes cash count audit apparatus 20 and Point of sale (POS) 70.

For better comprehension of present invention 10, the following definitions and terms for POS 70 are defined. POS 70, or checkout, is a place where a retail transaction is completed. It is the point at which a customer makes a payment to a merchant in exchange for goods and/or services. At POS 70 the merchant would use any of a range of possible methods to calculate the amount owing, such as a manual system, weighing machines, scanners or an electronic cash register. The merchant will usually provide hardware and options for use by the customer to make payment, such as an EFTPOS terminal. The merchant will also normally issue a receipt for the transaction. For small and medium-sized retailers, POS 70 will be customized by retail industry as different industries have different needs. For example, a grocery or candy store will need a scale at POS 70, while bars and restaurants will need to customize the item sold when a customer has a special meal or drink request. POS 70 also includes advanced functionalities to cater to different verticals, such as inventory, CRM, financials, warehousing, etc., all built into POS 70 software.

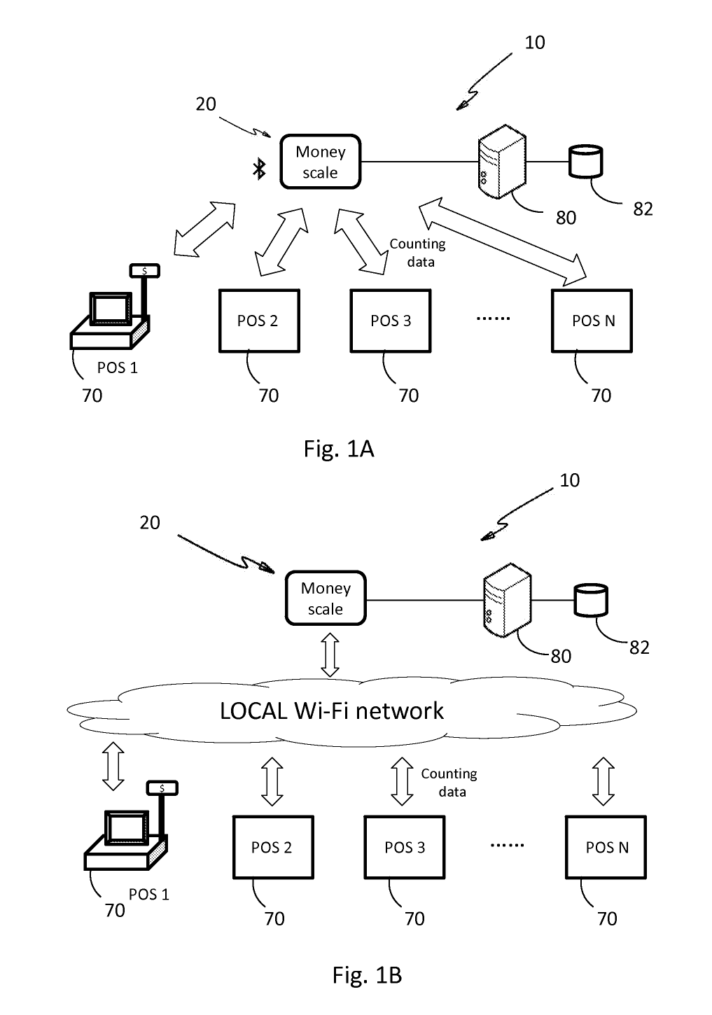

Seen in FIG. 1A is a preferred embodiment of instant invention 10 utilizing a wireless technology standard, for exchanging data over short distances using short-wavelength radio transmissions, at a stand-alone selling facility. Such a wireless technology standard can be “Bluetooth” as an example. At least one POS 70 communicates with cash count audit apparatus, also defined as money scale, 20. At the end of a shift, a cashier will balance his/her respective POS 70, whereby its drawer and its contents are taken to prepare a report. Cash count audit apparatus 20 documents, as part of the report, the cashier, manager, and/or otherwise authorized individual's signature and/or fingerprint after balancing his/her respective POS 70. The report is then transmitted to server 80 having database 82.

Seen in FIG. 1B is a first alternate embodiment of instant invention 10 utilizing a wireless local area network, at a stand-alone selling facility. At least one POS 70 communicates with cash count audit apparatus 20. At the end of a shift, a cashier will balance his/her respective POS 70, whereby its drawer and its contents are taken to prepare a report. Cash count audit apparatus 20 documents, as part of the report, the cashier, manager, and/or otherwise authorized individual's signature and/or fingerprint after balancing his/her respective POS 70. The report is then transmitted to server 80 having database 82.

Seen in FIG. 1C is a second alternate embodiment of instant invention 10 utilizing a local area network, at a stand-alone selling facility. At least one POS 70 communicates with cash count audit apparatus 20. At the end of a shift, a cashier will balance his/her respective POS 70, whereby its drawer and its contents are taken to prepare a report. Cash count audit apparatus 20 documents, as part of the report, the cashier, manager, and/or otherwise authorized individual's signature and/or fingerprint after balancing his/her respective POS 70. The report is then transmitted to server 80 having database 82.

Seen in FIG. 1D is a third alternate embodiment of instant invention 10 utilizing a barcode reader, at a stand-alone selling facility. At the end of a shift, a cashier will balance his/her respective POS 70, whereby its drawer and its contents are taken to prepare a report. POS 70 comprises printer 72 that prints report 74. Cash count audit apparatus 20 scans report 74, and documents the cashier, manager, and/or otherwise authorized individual's signature and/or fingerprint. The report is then transmitted to server 80 having database 82.

Instant invention 10 is designed to document POS 70 overages and/or shortages, reduce employee theft, and identify when further POS 70 training is required for a particular cashier.

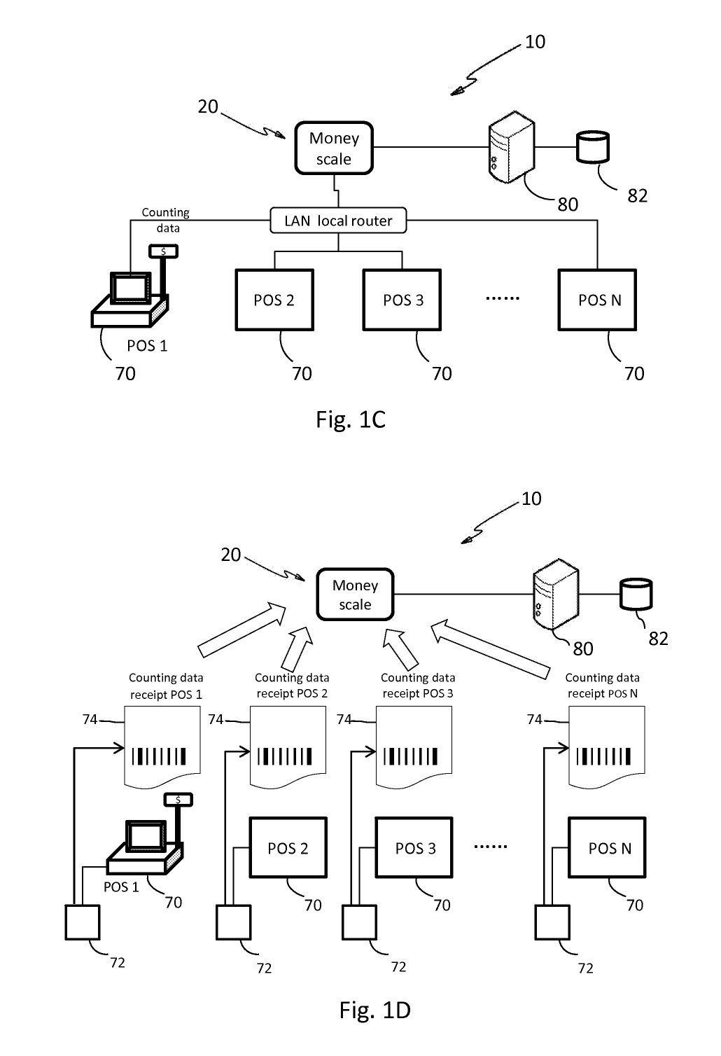

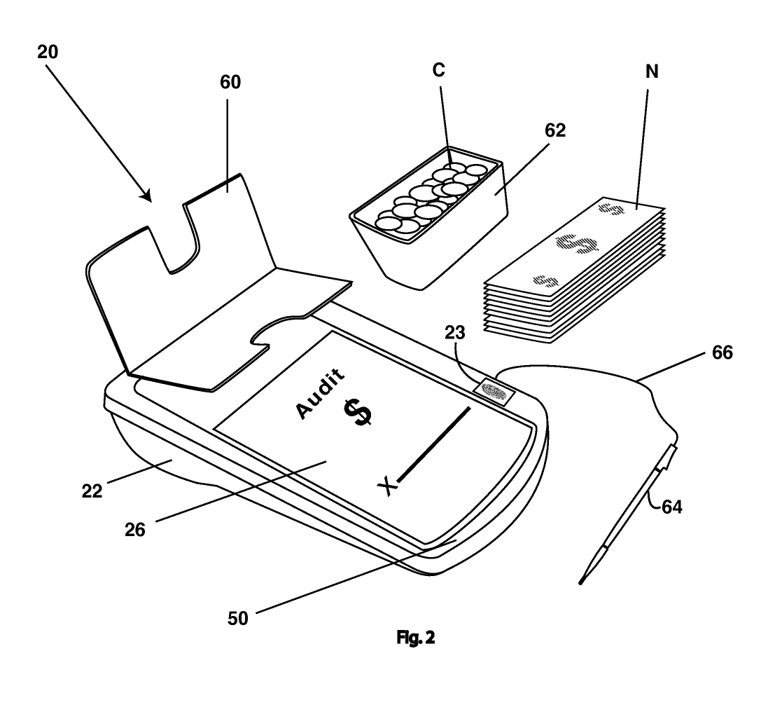

As seen in FIGS. 2 and 3, cash count audit apparatus 20 comprises base housing 22, and cover 24 that contains touchscreen 26 and fingerprint reader 23. Cash count audit apparatus 20 further comprises tray 60 cooperatively shaped to receive notes N directly thereon, or coin cup 62 containing coins C. Notes N are defined as bank notes or currency notes. Extending from base housing 22 is retractable cord 66 having stylus pen 64. Base housing 22 also comprises pen slot 50 to receive stylus pen 64.

As best seen in FIG. 3, positioned and/or mounted onto base housing 22 are main board 28, rechargeable battery 34, speaker 36, weight measure cell 38, and barcode reader interface 48. Main board 28 comprises imbedded DSM/wireless modem 29 for cellular communication abilities, Wi-Fi module 30 and “Bluetooth” module 32. DSM/wireless modem 29 is a device that allows computers to connect to a wireless local area network (WLAN) without physical cabling such as ethernet wiring. They use cellular, satellite or WiFi protocols to connect to a WLAN, which can then provide Internet service. Base housing 22 also comprises mounting posts that support touchscreen 26. It is noted that tray 60 comprises post 61. Cover 24 comprises hole 25 that is of a cooperative shape and dimension to receive post 61 there through to secure onto weight measure cell 38.

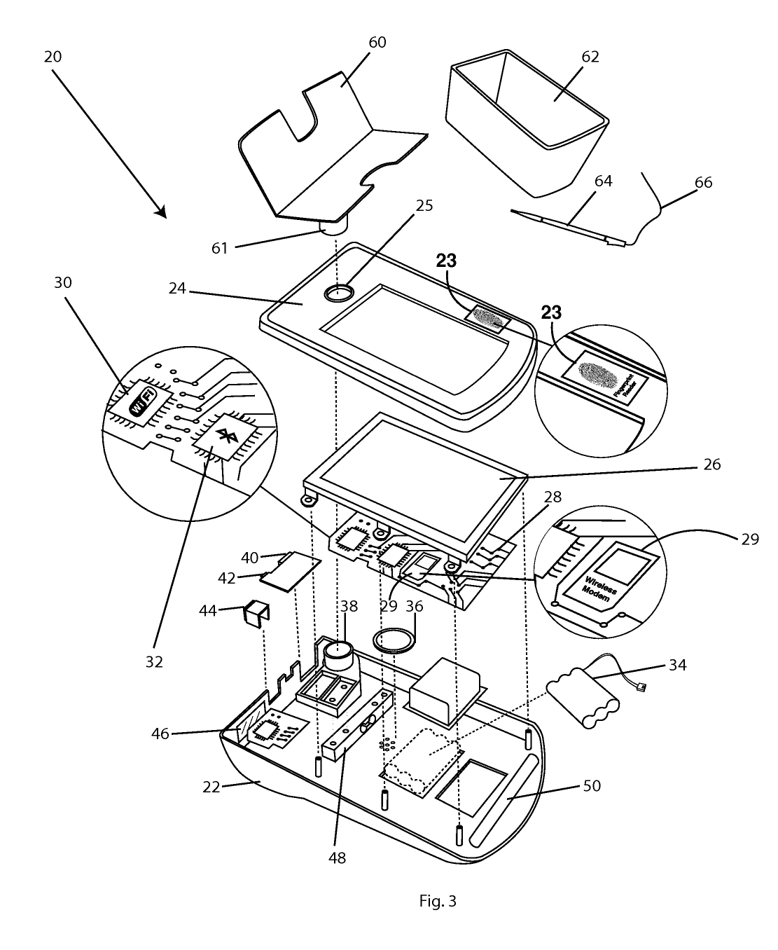

As best seen in FIG. 4, base housing 22 further comprises power supply connector 40, mini USB connector 42, LAN connector 44, and barcode reader window 46.

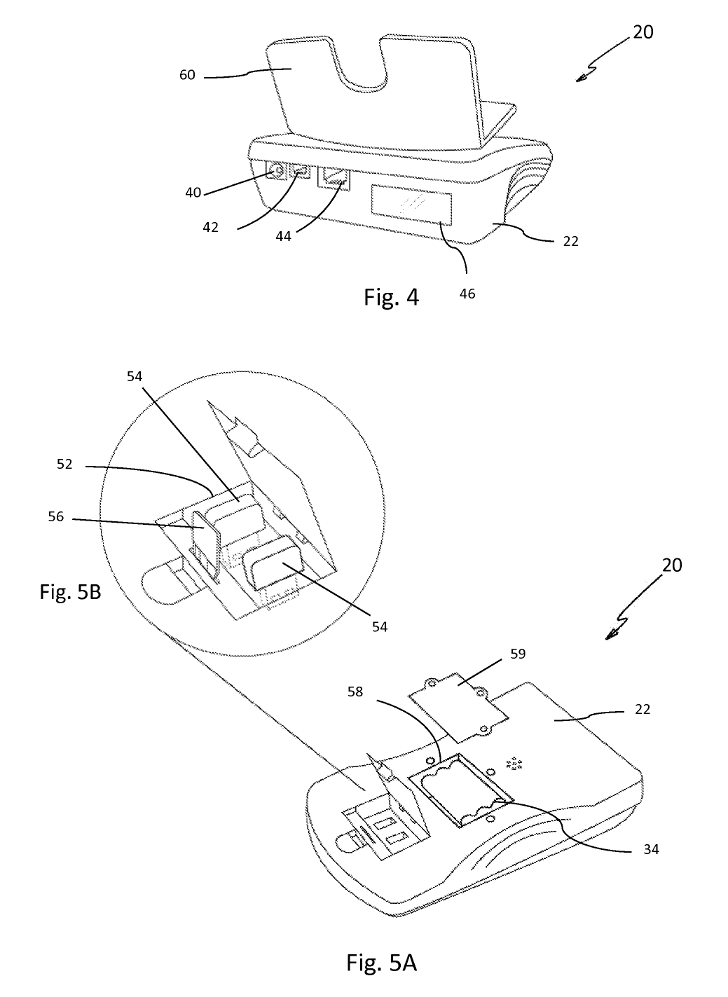

As seen in FIGS. 5A and 5B, base housing 22 further comprises accessories compartment 52 to contain “Bluetooth” dongles 54 and micro “SD” card 56. Base housing 22 further comprises battery compartment 58 having cover plate 59 to contain rechargeable battery 34.

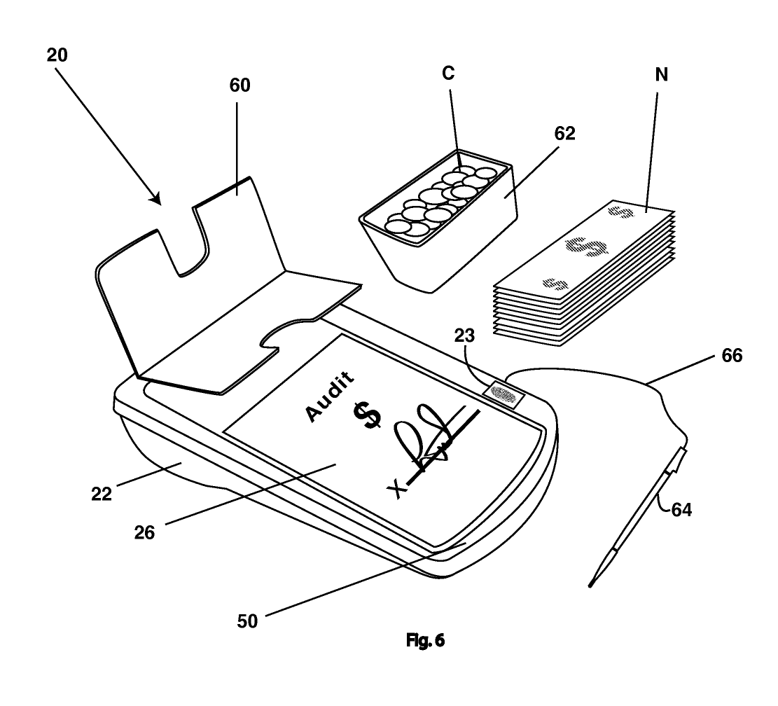

As seen in FIG. 6, cash count audit apparatus 20 documents a cashier, manager, and/or otherwise authorized individual's signature and/or fingerprint after balancing POS 70 utilizing stylus pen 64 having retractable cord 66, and/or fingerprint reader 23 respectively.

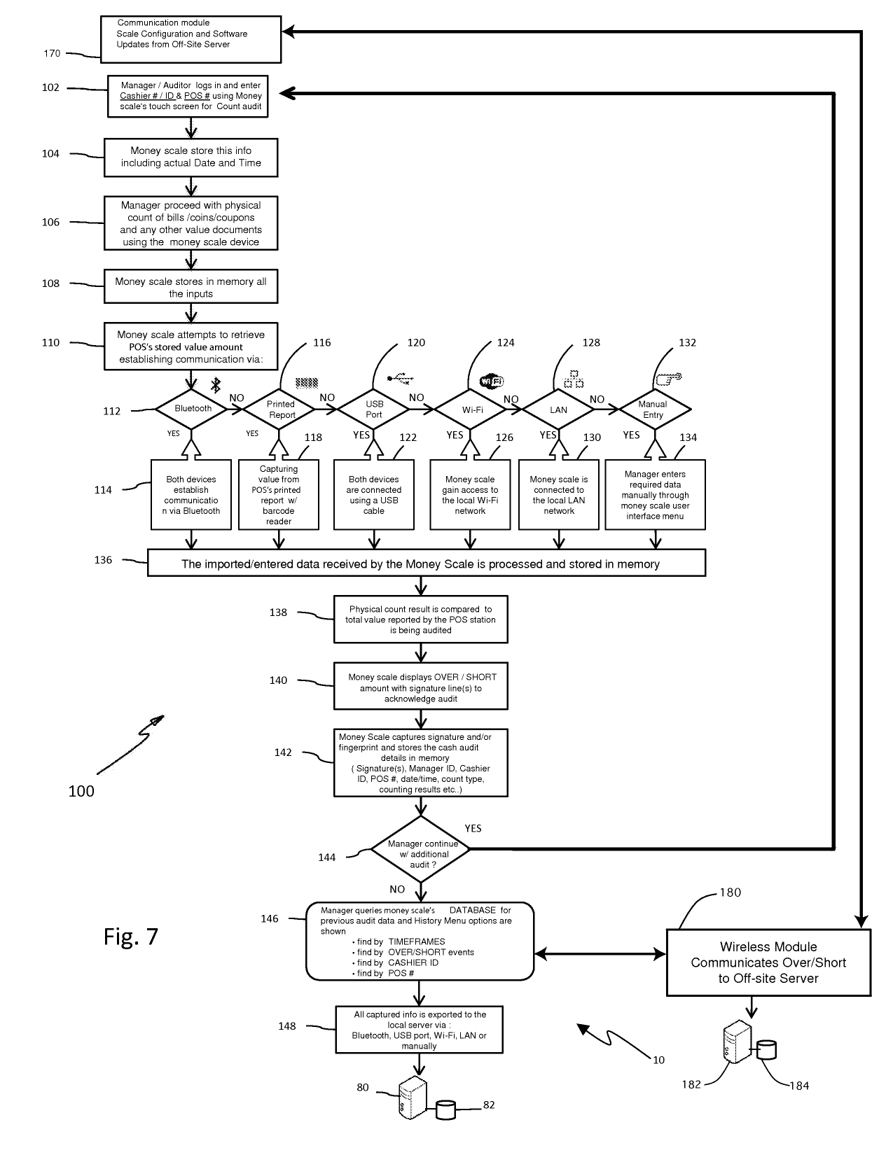

Instant invention 10 further comprises documenting means 100 to electronically capture and document the cashier, manager, and/or otherwise authorized individual's signature and/or fingerprint after balancing his/her respective POS 70. Documenting means 100 comprises the following steps illustrated in FIG. 7.

Seen in FIG. 7 is a flowchart of instant invention 10 in operation at a merchant having at least one POS 70, whereby cash count audit apparatus 20 documents, as part of the report, the cashier, manager, and/or otherwise authorized individual's signature and/or fingerprint after balancing his/her respective POS 70 and the report is then transmitted to server 80 having database 82.

Step 102—a manager logs in and enters a cashier number and/or identification and a respective POS 70 number using touch screen 26 to develop a cash count audit apparatus 20 report comprising amounts of cash for the respective POS 70.

Step 104—cash count audit apparatus 20 stores the information of Step 102 and generates report including actual date and time.

Step 106—manager proceeds with a physical count of cash including notes N and coins C using tray 60 of cash count audit apparatus 20. Depending on applicable store, company, and/or corporate policies, the cashier, a manager, and/or otherwise an authorized individual, or plurality thereof, may sign their respective signature onto touchscreen 26, and/or place his/her finger onto fingerprint reader 23 when the cash is counted. Accountability is an objective of this step.

Step 108—cash count audit apparatus 20 stores in memory all the inputs of the prior steps.

Step 110—cash count audit apparatus 20 attempts to retrieve POS 70's stored value amounts establishing communication via Steps 112; 114; 116; 118; 120; 122; 124; 126; 128; 130; 132; and 134. It is noted that the order of steps 112; 114; 116; 118; 120; 122; 124; 126; 128; 130; 132; and 134 below are an example, and depending on specific location geography, logistics, and configurations, the order may be modified. For purposes of demonstration, the steps are outlines as follows:

Step 112—via a wireless technology standard, “Bluetooth”. Step 114—communication via “Bluetooth” is established and proceed to Step 136—The imported/entered data received by cash count audit apparatus 20 is processed and stored in memory; otherwise proceed to Step 116.

Step 116—via a printed report. Step 118—capturing a value from POS 70 printed report with a barcode reader and proceed to Step 136—The imported/entered data received by cash count audit apparatus 20 is processed and stored in memory; otherwise proceed to Step 120.

Step 120—via a USB port. Step 122—POS 70 and cash count audit apparatus 20 are connected using a USB cable and proceed to Step 136—The imported/entered data received by cash count audit apparatus 20 is processed and stored in memory; otherwise proceed to Step 124.

Step 124—via Wi-Fi. Step 126—communication via Wi-Fi is established and proceed to Step 136—The imported/entered data received by cash count audit apparatus 20 is processed and stored in memory; otherwise proceed to Step 128.

Step 128—via LAN. Step 130—communication via LAN is established and proceed to Step 136—The imported/entered data received by cash count audit apparatus 20 is processed and stored in memory; otherwise proceed to Step 132.

Step 132—Manual entry. Step 134—the manager enters required data manually through touchscreen 26 and proceed to Step 136—The imported/entered data received by cash count audit apparatus 20 is processed and stored in memory.

Step 138—the physical count result is compared to a total value reported by the POS 70 being audited.

Step 140—cash count audit apparatus 20 displays overages and/or shortages and prompts the respective cashier, manager, and/or otherwise authorized individual's signature and/or fingerprint to acknowledge the audit.

Step 142—cash count audit apparatus 20 captures and documents the cashier, manager, and/or otherwise authorized individual's signature and/or fingerprint. In one embodiment, the cash count audit apparatus 20 report comprises: the cashier, manager, and/or otherwise authorized individual's signature(s) and/or fingerprint(s), a manager identification, a cashier identification, POS 70's number, the date, the time, the count type, and the counting results.

Step 144—cash count audit apparatus 20 prompts the manager if an additional count is desired. If yes, proceed to Step 102; otherwise proceed to Step 146.

Step 146—the manager queries cash count audit apparatus 20 database for previous audit data if necessary.

Step 148—All captured info is exported to local server 80 via “Bluetooth”, USB port, Wi-Fi, LAN, manually, or by other means and optionally stored in database 82.

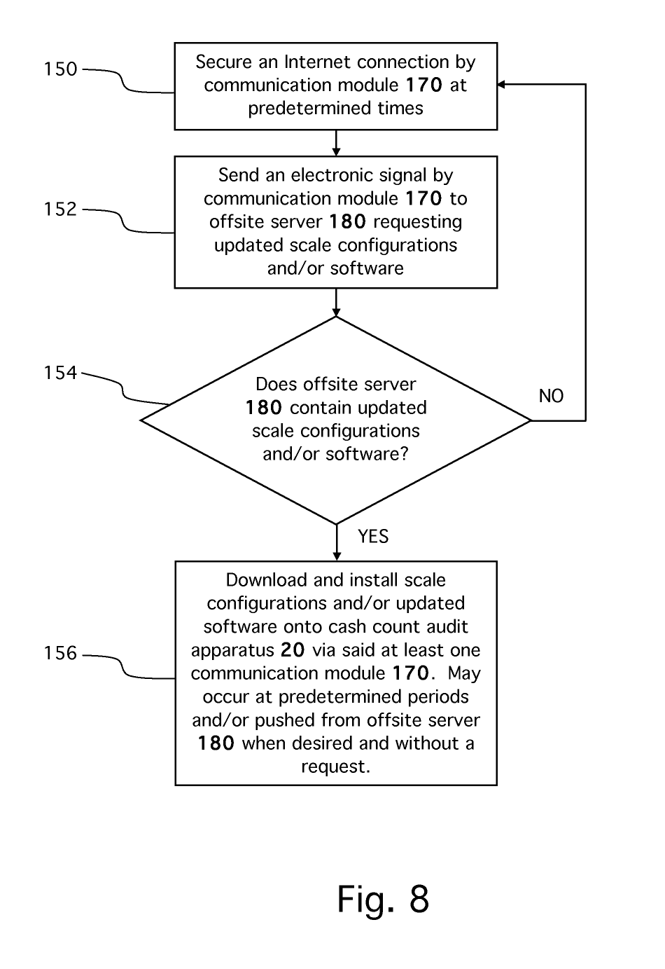

As seen in FIG. 8, instant invention 10 further comprises updating means for scale configurations of cash count audit apparatuses 20 and/or software updating from offsite server 180, comprising the steps of:

Step 150—securing an Internet connection by said at least one communication module 170 at predetermined times;

Step 152—sending an electronic signal by said at least one communication module 170 to offsite server 180 requesting updated scale configurations and/or software;

Step 154—proceeding to Step 150 if offsite server 180 does not contain updated scale configurations and/or software, and proceeding to Step 156 otherwise; and

Step 156—downloading and installing said scale configurations and/or updated software onto said cash count audit apparatus 20 via said at least one communication module 170. Said downloading and installing of said updated scale configurations and/or software may occur at predetermined periods and/or pushed from said offsite server 180 when desired and without a request. Offsite server 180 comprises server 182 having database 184.

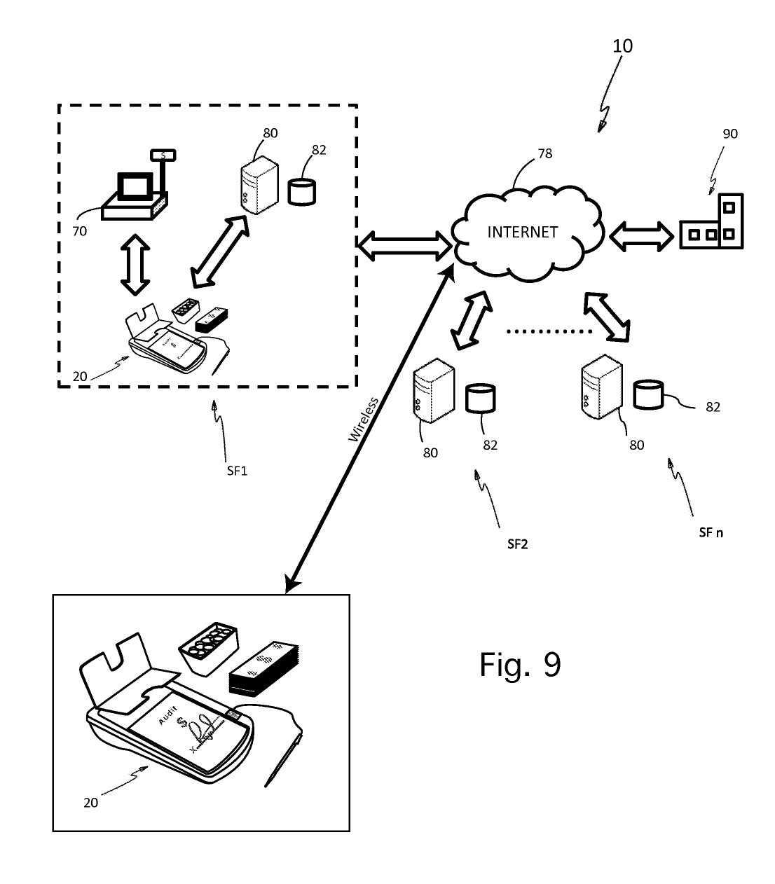

As illustrated in FIG. 9, present invention 10 is configured to operate at multiple selling facilities SF1, SF2, and SFn. It is noted that for simplicity, only present invention 10 within selling facility SF1 is illustrated since the selling facilities SF2 and SFn would duplicate that of selling facility SF1.

From each selling facilities SF1, SF2, and SFn, resulting reports, data, communications, and information may be transmitted through Internet 78 defined as the world-wide-web to operating business 90.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A cash count auditing system, comprising:
A) a cash count audit apparatus;
B) a POS; and
C) documenting means to electronically capture and document a signature and/or fingerprint after balancing a respective said POS.

2. The cash count auditing system set forth in claim 1, further characterized in that said signature and/or fingerprint, as part of a report is transmitted to a server having at least one database.

3. The cash count auditing system set forth in claim 2, further comprising a wireless technology standard, for exchanging data over short distances using short-wavelength radio transmissions, wherein at least one said POS communicates with its respective cash count audit apparatus, and at predetermined time periods, a cashier will balance a respective said POS, whereby its drawer and its contents are taken to prepare said report.

4. The cash count auditing system set forth in claim 2, further comprising a wireless local area network, wherein at least one said POS communicates with its respective cash count audit apparatus, and at predetermined time periods, a cashier will balance a respective said POS, whereby its drawer and its contents are taken to prepare said report.

5. The cash count auditing system set forth in claim 2, further comprising a local area network, wherein at least one said POS communicates with its respective cash count audit apparatus, and at predetermined time periods, a cashier will balance a respective said POS, whereby its drawer and its contents are taken to prepare said report.

6. The cash count auditing system set forth in claim 2, further comprising a barcode reader, and at predetermined time periods, a cashier will balance a respective said POS, whereby its drawer and its contents are taken to prepare said report, said respective said POS comprises printer that prints said report and said cash count audit apparatus scans said report and documents said signature and/or fingerprint.

7. The cash count auditing system set forth in claim 1, further characterized in that said cash count audit apparatus comprises a base housing, and a cover that contains a touchscreen and a fingerprint reader.

8. The cash count auditing system set forth in claim 7, further characterized in that said cash count audit apparatus further comprises a tray cooperatively shaped to receive notes directly thereon, and/or a coin cup.

9. The cash count auditing system set forth in claim 8, further characterized in that positioned and/or mounted onto said base housing are a main board, a rechargeable battery, a speaker, a weight measure cell, and/or a barcode reader interface.

10. The cash count auditing system set forth in claim 9, further characterized in that said main board comprises a first module for enabling wireless communications, and/or a second module wireless technology standard, for exchanging data over short distances using short-wavelength radio transmissions and a DSM/wireless modem.

11. The cash count auditing system set forth in claim 8, further characterized in that said tray comprises a post, and said cover comprises a hole that is of a cooperative shape and dimension to receive said post there through to secure onto said weight measure cell.

12. The cash count auditing system set forth in claim 7, further characterized in that said base housing comprises a power supply connector, a mini USB connector, a LAN connector, and/or a barcode reader window.

13. The cash count auditing system set forth in claim 7, further characterized in that said base housing comprises a battery compartment having a cover plate to contain at least one rechargeable battery.

14. The cash count auditing system set forth in claim 1, said documenting means comprises the following steps:
D) logging in and entering a cashier number and/or identification and a respective said POS number using a touch screen on said cash count audit apparatus, to develop a cash count audit apparatus report comprising amounts of cash for a respective said POS.

15. The cash count auditing system set forth in claim 14, said documenting means further comprises the following steps:
E) generating said report including actual date and time.

16. The cash count auditing system set forth in claim 15, said documenting means further comprises the following steps:
F) physically counting said cash of respective said POS including notes and coins using a tray of said cash count audit apparatus.

17. The cash count auditing system set forth in claim 16, said documenting means further comprises the following steps:
G) retrieving respective said POS stored value amounts, establishing communication and imported/entered data received by said cash count audit apparatus is processed and stored in computer memory.

18. The cash count auditing system set forth in claim 17, said documenting means further comprises the following steps:
H) comparing a physical count result to a total value reported by said POS being audited, said cash count audit apparatus displays overages and/or shortages and prompts a respective said signature and/or fingerprint to acknowledge the audit.

19. The cash count auditing system set forth in claim 2, further characterized in that at least one said cash count audit apparatus and at least one said POS are configured to operate at multiple selling facilities, from each said selling facilities, resulting said reports, data, communications, and information may be transmitted through a world-wide-web to an operating business.

20. The cash count auditing system set forth in claim 1, further comprising updating means comprising the steps of:
D) securing an internet connection by at least one communication module;
E) sending an electronic signal by said at least one communication module to an offsite server requesting updated scale configurations and/or software;
F) proceeding to Step D if said offsite server does not contain said updated scale configurations and/or software, and proceeding to Step G otherwise; and
G) downloading and installing said updated scale configurations and/or software onto said cash count audit apparatus, said downloading and installing of said updated scale configurations and/or software may occur at predetermined periods and/or pushed from said offsite server when desired and without a request.
